(19) United States
(12) Patent Application Publication
(10) Pub. No.: US 2024/0259806 A1
(43) Pub. Date: Aug. 1, 2024

(54) APPARATUS, SYSTEM, AND METHOD OF PROTECTING A WIRELESS COMMUNICATION FRAME

(71) Applicants: Po-Kai Huang, San Jose, CA (US); Ido Ouzieli, Tel Aviv (IL); Danny Alexander, Monoson (IL)

(72) Inventors: Po-Kai Huang, San Jose, CA (US); Ido Ouzieli, Tel Aviv (IL); Danny Alexander, Monoson (IL)

(21) Appl. No.: 18/635,377

(22) Filed: Apr. 15, 2024

Related U.S. Application Data
(60) Provisional application No. 63/507,728, filed on Jun. 12, 2023.

(51) Int. Cl. H04W 12/106; H04L 5/00; H04W 12/06

(52) U.S. Cl. CPC H04W 12/106; H04L 5/0053; H04W 12/06

(57) ABSTRACT

For example, a wireless communication station (STA) may be configured to set a Message Integrity Code (MIC) in a MIC field to protect contents of a control frame according to a Galois Message Authentication Code with 256-bit cipher-key (GMAC-256) protection mechanism. For example, the MIC may be based on a Packet Number (PN). For example, a size of the MIC field may be less than 16 bytes. For example, the STA may be configured to set a PN field based on the PN. For example, a size of the PN field may be less than 6 bytes. For example, the STA may be configured to transmit the control frame including the MIC field and the PN field.

### CROSS REFERENCE

This application claims the benefit of, and priority from, U.S. Provisional Patent Application No. 63/507,728 entitled “CODE TRUNCATION FOR CONTROL FRAME AND MEDIUM ACCESS CONTROL (MAC) HEADER PROTECTION”, filed Jun. 12, 2023, the entire disclosure of which is incorporated herein by reference.

### BACKGROUND

Wireless communication device may be configured to communicate according to wireless communication protocols, which may utilize various protection mechanisms to protect the contents and/or the integrity of some types of frames, e.g., management frames.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of control frame protection, in accordance with some demonstrative aspects.

FIG. 3 is a schematic flow-chart illustration of a method of control frame protection, in accordance with some demonstrative aspects.

FIG. 4 is a schematic flow-chart illustration of a method of Medium Access Control (MAC) header protection, in accordance with some demonstrative aspects.

FIG. 5 is a schematic flow-chart illustration of a method of MAC header protection, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D5.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn Ultra High Reliability (UHR))), devices and/or networks operating in accordance with existing National Institute of Standards and Technology (NIST) Specifications (including NIST Special Publication 800-38C (Recommendation for Block Cipher Modes of Operation: The CCM Mode for Authentication and Confidentiality, May 2004); and/or NIST Special Publication 800-38D (Recommendation for Block Cipher Modes of Operation: Galois/Counter Mode (GCM) and GMAC, November 2007)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHZ, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

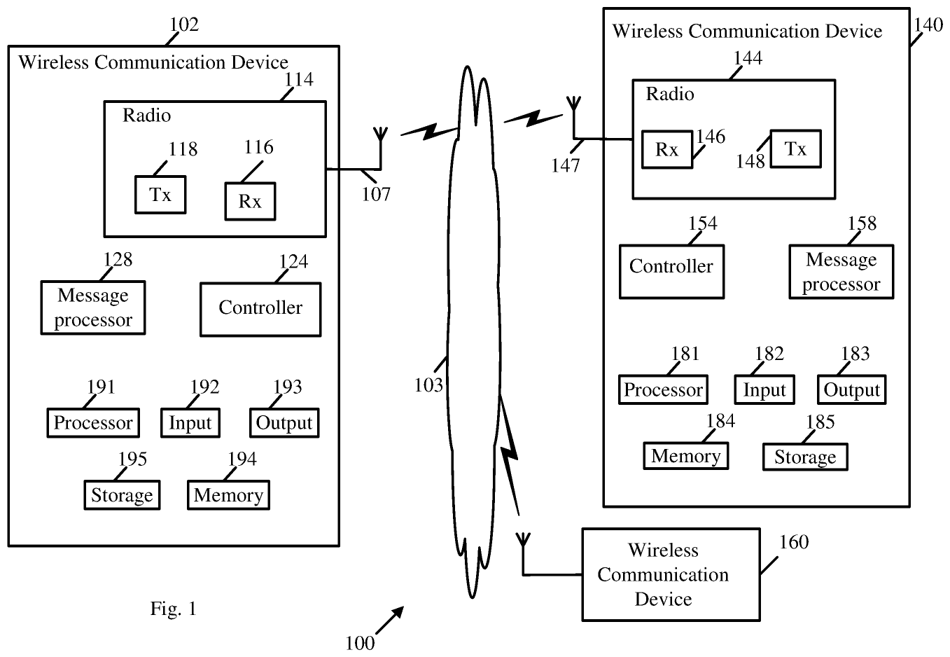

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, and/or any other specification and/or protocol.

In some demonstrative aspects, device 102 may include, operate as, perform a role of, and/or perform the functionality of, an AP STA.

In some demonstrative aspects, device 140, and/or device 160 may include, operate as, perform a role of, and/or perform the functionality of, one or more non-AP STAs. For example, device 140 may include, operate as, perform a role of, and/or perform the functionality of, at least one non-AP STA, and/or device 160 may include, operate as, perform a role of, and/or perform the functionality of, at least one non-AP STA.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may be configured to implement one or more operations and/or functionalities of a frame protection mechanism, which may be configured to protect wireless communication frames, e.g., as described below.

In some demonstrative aspects, device 102, device 140, and/or device 160 may be configured to implement a frame protection mechanism, which may be configured to support control frame protection for a control frame, for example, a trigger frame, a Block Acknowledgement Request (BAR) frame, Block Acknowledgement (BA) frame, and/or any other additional or alternative type of control frame, e.g., as described below.

In some demonstrative aspects, the frame protection mechanism may be configured to support the control frame protection, for example, by accommodating one or more types of control frames, which may use a broadcast address, e.g., as described below.

For example, control frames, which use a broadcast address, may include one or more, e.g., some or all, variants of trigger frames with more than one user info field, e.g., an MU-BAR (a variant of a trigger frame), a Multi-STA BA, and/or any other additional or alternative type of trigger frame.

In some demonstrative aspects, the frame protection mechanism may be configured to support protection of broadcast address control frames. For example, the frame protection mechanism may be implemented by a transmitter of a control frame to include a Message Integrity Code (MIC) (also referred to as “tag”) and/or a Packet Number (PN) in a control frame. For example, the frame protection mechanism may be implemented by a receiver of the control frame, for example, to verify the integrity of the control frame, for example, using the MIC and/or the PN, e.g., as described below.

For example, the MIC and/or PN may be implemented to protect broadcast addressed frames, for example, according to a Broadcast/multicast Integrity Protocol (BIP). For example, the BIP may utilize on more fields, e.g., a PN field and/or a MIC field, which may be included in some types of management frames, for example, group addressed beacon frames, disassociation frames, and/or dis-authentication frames.

For example, the BIP may utilize a PN field behaving a size of 6 bytes.

For example, the BIP may utilize a MIC field having a size of 8 bytes, e.g., according to a Cipher-Based Message Authentication Code (CMAC) with 128-bit cipher-key (CMAC-128), or a size of 16 bytes, e.g., according to a CMAC with 256-bit cipher-key (CMAC-256), a Galois Message Authentication Code (GMAC) with 128-bit cipher-key (GMAC-128), or GMAC with 256-bit cipher-key (GMAC-256).

In some demonstrative aspects, device 102, device 140, and/or device 160 may be configured to implement one or more operations and/or functionalities of a control frame protection mechanism, which may be configured to support protection of control frames, e.g., as described below.

In some demonstrative aspects, the control frame protection mechanism may be configured according to one or more technical considerations, criteria, parameters, attributes, constraints, and/or imitations, which may be related to the communication of control frames, may characterize the communication of control frames, and/or may distinguish the communication of control frames from other types of frames, e.g., as described below.

In some demonstrative aspects, the control frame protection mechanism may be configured according to one or more technical considerations relating to a frequency at which control frames may be transmitted.

For example, some control frames may be sent with relatively high frequency, e.g., compared to management frames.

For example, a trigger frame may be sent for every UL transmission.

For example, a Multi-STA BA frame may be sent for every instance of an UL MU data transmission sequence.

For example, an MU-BAR frame may potentially be sent for every instance of a DL MU data transmission sequence.

In some demonstrative aspects, the relatively high frequency at which control frames may be communicated may be taken into consideration, for example, with respect to overhead incurred by frame protection fields, e.g., as described below.

In some demonstrative aspects, device 102, device 140, and/or device 160 may be configured to implement one or more operations and/or functionalities of a control frame protection mechanism, which may be configured to support protection of group addressed control frames, e.g., as described below.

In some demonstrative aspects, device 102, device 140, and/or device 160 may be configured to implement one or more operations and/or functionalities of a control frame protection mechanism, which may be configured to support protection of individually addressed control frames, e.g., as described below.

In one example, individually addressed control frames may be protected, for example, by reusing an integrity-only protection mechanism, e.g., a MIC-only mechanism, for example, according to the BIP. In another example, a direct encryption mechanism, e.g., a Counter Mode with Cipher Block Chaining Message (CCMP) or Galois Mode with Cipher Block Chaining Message (GCMP), may be used.

In some demonstrative aspects, device 102, device 140, and/or device 160 may be configured to implement one or more operations and/or functionalities of a MAC header protection mechanism, which may be configured to support protection of a MAC header, e.g., as described below.

In some demonstrative aspects, device 102, device 140, and/or device 160 may be configured to implement one or more operations and/or functionalities of a MAC header protection mechanism, which may be configured to support protection of a MAC header for management frames and/or data frames, e.g., as described below.

In some demonstrative aspects, the MAC header protection mechanism may be configured to support MAC header protection according to a MIC-only mechanism.

In some demonstrative aspects, the MAC header protection mechanism may be configured to support MAC header protection according to an encryption mechanism.

In some demonstrative aspects, device 102, device 140, and/or device 160 may be configured to implement one or more operations and/or functionalities of a protection mechanism, which may be configured to utilize a truncated MIC field and/or a truncated PN field, for example, for control frame protection and/or for MAC header protection, e.g., as described below.

In some demonstrative aspects, the protection mechanism may be configured to implement a truncation technique, for example, to support truncation of the MIC field and/or a truncated PN field.

In some demonstrative aspects, the protection mechanism may be configured to implement the truncation technique, for example, to provide a technical solution to reduce potential overhead, which may be associated with the MIC field and/or the PN field, e.g., as described below.

In some demonstrative aspects, device 102, device 140, and/or device 160 may be configured to implement one or more operations and/or functionalities of a protection mechanism, which may be configured to support truncation of a MIC field and/or a PN field, for example, for protection of control frames, e.g., as described below.

In some demonstrative aspects, device 102, device 140, and/or device 160 may be configured to implement one or more operations and/or functionalities of a protection mechanism, which may be configured to support truncation of a MIC field and/or a PN field, for example, for protection of group addressed control frames, e.g., as described below.

In some demonstrative aspects, device 102, device 140, and/or device 160 may be configured to implement one or more operations and/or functionalities of a protection mechanism, which may be configured to support truncation of a MIC field and/or a PN field, for example, for protection of individually addressed control frames, e.g., as described below.

In some demonstrative aspects, device 102, device 140, and/or device 160 may be configured to implement one or more operations and/or functionalities of a protection mechanism, which may be configured to support truncation of a MIC field and/or a PN field, for example, for protection of a MAC header, e.g., as described below.

In some demonstrative aspects, device 102, device 140, and/or device 160 may be configured to implement one or more operations and/or functionalities of a protection mechanism, which may, utilize a CMAC protection mechanism, for example, in compliance with one or more NIST Specifications, e.g., NIST Special Publication 800-38C and/or NIST Special Publication 800-38D.

In other aspects, the protection mechanism may utilize any other additional or alternative authentication code.

In some demonstrative aspects, the protection mechanism may be configured to utilize a truncated PN field and/or a truncated MIC field, e.g., as described below.

In some demonstrative aspects, the protection mechanism may be configured to support truncation of the PN field and/or truncation of the MIC field, for example, for frame protection, for example, in compliance with one or more NIST Specifications, e.g., NIST Special Publication 800-38C and/or NIST Special Publication 800-38D.

In some demonstrative aspects, controller 124 may be configured to control, trigger, cause, and/or instruct a STA implemented by device 102 to protect contents of a control frame to be transmitted by the STA, for example, according to a control frame protection mechanism, e.g., as described below.

In some demonstrative aspects, controller 124 may be configured to control, trigger, cause, and/or instruct the STA implemented by device 102 to set a MIC in a MIC field to protect contents of the control frame, for example, according to a GMAC-256 protection mechanism, e.g., as described below.

In some demonstrative aspects, the MIC field may be configured to have a size of less than 16 bytes, e.g., as described below.

In some demonstrative aspects, the MIC field may be configured to have a size of 8 bytes, e.g., as described below.

In some demonstrative aspects, the MIC field may be configured to have a size of 4 bytes, e.g., as described below.

In other aspects, the MIC field may be configured to have any other size, e.g., less than 16 bytes.

In some demonstrative aspects, the MIC may be based on a PN, e.g., as described below.

In some demonstrative aspects, controller 124 may be configured to control, trigger, cause, and/or instruct the STA implemented by device 102 to set a PN field, for example, based on the PN, e.g., as described below.

In some demonstrative aspects, the PN field may be configured to have a size of less than 6 bytes, e.g., as described below.

In some demonstrative aspects, the PN field may be configured to have a size of 4 bytes, e.g., as described below.

In some demonstrative aspects, the PN field may be configured to have a size of 3 bytes.

In other aspects, the PN field may be configured to have any other size, e.g., less than 6 bytes.

In some demonstrative aspects, controller 124 may be configured to control, trigger, cause, and/or instruct the STA implemented by device 102 transmit the control frame including the MIC field and the PN field, e.g., as described below.

In some demonstrative aspects, the control frame may include a trigger frame, e.g., as described below.

In some demonstrative aspects, the control frame may include a BA frame, e.g., as described below.

In some demonstrative aspects, the control frame may include a BAR frame, e.g., as described below.

In other aspects, the control frame may include any other additional or alternative type of control frame.

In some demonstrative aspects, the control frame may include a group addressed control frame, e.g., as described below.

In some demonstrative aspects, the control frame may include an individually addressed control frame, e.g., as described below.

In some demonstrative aspects, the control frame may include a frame control field including a type subfield set to “01”, for example, to indicate that a control frame type, e.g., as described below.

In other aspects, the type subfield may be set to any other additional or alternative value, e.g., to indicate the control frame type.

In some demonstrative aspects, controller 124 may be configured to control, trigger, cause, and/or instruct the STA implemented by device 102 to set the PN field to a first PN value having a size of less than 6 bytes, e.g., as described below.

In some demonstrative aspects, controller 124 may be configured to control, trigger, cause, and/or instruct the STA implemented by device 102 to determine the MIC, for example, according to a second PN value having a size of 6 bytes, e.g., as described below.

In some demonstrative aspects, the second PN value may be based on the first PN value, e.g., as described below.

In some demonstrative aspects, the second PN value may include the first PN value appended with a predefined bit sequence, e.g., as described below.

In some demonstrative aspects, the predefined bit sequence may be configured to have a length equal to a difference between 6 bytes and the size of the first PN value, e.g., as described below.

In some demonstrative aspects, the predefined bit sequence may include an all-zeros sequence.

In other aspects, the predefined bit sequence may include any other sequence, for example, an all-ones sequence, and/or any other additional or alternative sequence.

In some demonstrative aspects, controller 154 may be configured to control, trigger, cause, and/or instruct a STA implemented by device 140 to process a control frame received from another STA to identify a PN field, e.g., as described below.

In some demonstrative aspects, controller 154 may be configured to control, trigger, cause, and/or instruct the STA implemented by device 140 to process the control frame to identify a MIC in a MIC field, e.g., as described below.

In some demonstrative aspects, the MIC field may have a size of less than 16 bytes, as described below.

In some demonstrative aspects, the PN field may have a size of less than 6 bytes, as described below.

In some demonstrative aspects, controller 154 may be configured to control, trigger, cause, and/or instruct the STA implemented by device 140 to authenticate contents of the control frame, for example, according to a control frame protection mechanism, e.g., as described below.

In some demonstrative aspects, controller 154 may be configured to control, trigger, cause, and/or instruct the STA implemented by device 140 to authenticate contents of the control frame, for example, according to a GMAC-256 protection mechanism, e.g., as described below.

In some demonstrative aspects, controller 154 may be configured to control, trigger, cause, and/or instruct the STA implemented by device 140 to authenticate contents of the control frame, for example, based on the MIC in the MIC field and the PN field, e.g., as described below.

In some demonstrative aspects, controller 154 may be configured to control, trigger, cause, and/or instruct the STA implemented by device 140 to authenticate contents of the control frame, for example, based on the MIC in the MIC field and the PN field, for example, according to the GMAC-256 protection mechanism, e.g., as described below.

In some demonstrative aspects, the control frame received by the STA implemented by device 140 may include the control frame transmitted by the STA implemented by device 102, e.g., as described above.

In some demonstrative aspects, controller 154 may be configured to control, trigger, cause, and/or instruct the STA implemented by device 140 to identify a first PN value having a size of less than 6 bytes in the PN field, e.g., as described below.

In some demonstrative aspects, controller 154 may be configured to control, trigger, cause, and/or instruct the STA implemented by device 140 to determine a calculated MIC, for example, according to a second PN value having a size of 6 bytes, e.g., as described below.

In some demonstrative aspects, the second PN value may be based on the first PN value, e.g., as described below.

In some demonstrative aspects, the second PN value may include the first PN value appended with a predefined bit sequence, e.g., as described below.

In some demonstrative aspects, the predefined bit sequence may be configured to have a length equal to a difference between 6 bytes and the size of the first PN value, e.g., as described below.

In some demonstrative aspects, the predefined bit sequence may include an all-zeros sequence, e.g., as described below.

In other aspects, the predefined bit sequence may include any other sequence, for example, an all-ones sequence, and/or any other additional or alternative sequence.

In some demonstrative aspects, controller 154 may be configured to control, trigger, cause, and/or instruct the STA implemented by device 140 to authenticate the contents of the control frame, for example, based on a comparison between the calculated MIC and the MIC in the MIC field, e.g., as described below.

In some demonstrative aspects, controller 124 may be configured to control, trigger, cause, and/or instruct the STA implemented by device 102 to protect contents of one or more subfields of a MAC header (“the one or more protected MAC header subfields”) of a frame, for example, according to a MAC header protection mechanism, e.g., as described below.

In some demonstrative aspects, controller 124 may be configured to control, trigger, cause, and/or instruct the STA implemented by device 102 to protect contents of the one or more subfields of the MAC header of the frame, for example, according to a GMAC-256 protection mechanism, e.g., as described below.

In some demonstrative aspects, controller 124 may be configured to control, trigger, cause, and/or instruct the STA implemented by device 102 to set a MIC in a MIC field to protect contents of the one or more subfields of the MAC header of the frame, for example, according to the GMAC-256 protection mechanism, e.g., as described below.

In some demonstrative aspects, the MIC field may be configured to have a size of less than 16 bytes, e.g., as described below.

In some demonstrative aspects, the MIC field may be configured to have a size of 8 bytes.

In some demonstrative aspects, the MIC field may be configured to have a size of 4 bytes.

In other aspects, the MIC field may be configured to have any other size, e.g., less than 16 bytes.

In some demonstrative aspects, the MIC may be based on a PN, e.g., as described below.

In some demonstrative aspects, controller 124 may be configured to control, trigger, cause, and/or instruct the STA implemented by device 102 to set a PN field, for example, based on the PN, e.g., as described below.

In some demonstrative aspects, the PN field may be configured to have a size of less than 6 bytes, e.g., as described below.

In some demonstrative aspects, the PN field may be configured to have a size of 4 bytes.

In some demonstrative aspects, the PN field may be configured to have a size of 3 bytes.

In other aspects, the PN field may be configured to have any other size, e.g., less than 6 bytes.

In some demonstrative aspects, controller 124 may be configured to control, trigger, cause, and/or instruct the STA implemented by device 102 to transmit a frame including the MAC header, which includes the MIC field and the PN field, e.g., as described below.

In some demonstrative aspects, the one or more protected MAC header subfields may include a sequence control subfield, e.g., as described below.

In some demonstrative aspects, the one or more protected MAC header subfields may include a Quality of Service (QOS) control subfield, e.g., as described below.

In some demonstrative aspects, the one or more protected MAC header subfields may include an HT control subfield, e.g., as described below.

In some demonstrative aspects, the one or more protected MAC header subfields may include a Power Management (PM) subfield, e.g., as described below.

In other aspects, the one or more protected MAC header subfields may include any other additional or alternative subfield of the MAC header.

In some demonstrative aspects, the frame including the one or more protected MAC header subfields may include a management frame, e.g., as described below.

In some demonstrative aspects, the management frame may include a frame control field, which includes a type subfield set to “00”, e.g., as described below.

In some demonstrative aspects, the frame including the one or more protected MAC header subfields may include a data frame, e.g., as described below.

In some demonstrative aspects, the data frame may include a frame control field, which includes a type subfield set to “10”, e.g., as described below.

In other aspects, the frame including the one or more protected MAC header subfields may include any other type of frame.

In some demonstrative aspects, the frame including the one or more protected MAC header subfields may include a group addressed frame, e.g., as described below.

In some demonstrative aspects, the frame including the one or more protected MAC header subfields may include an individually addressed frame, e.g., as described below.

In some demonstrative aspects, controller 124 may be configured to control, trigger, cause, and/or instruct the STA implemented by device 102 to set the PN field to a first PN value having a size of less than 6 bytes, e.g., as described below.

In some demonstrative aspects, controller 124 may be configured to control, trigger, cause, and/or instruct the STA implemented by device 102 to determine the MIC, for example, according to a second PN value having a size of 6 bytes, e.g., as described below.

In some demonstrative aspects, the second PN value may be based on the first PN value, e.g., as described below.

In some demonstrative aspects, the second PN value may include the first PN value appended with a predefined bit sequence, e.g., as described below.

In some demonstrative aspects, the predefined bit sequence may have a length equal to a difference between 6 bytes and the size of the first PN value, e.g., as described below.

In some demonstrative aspects, the predefined bit sequence may include an all-zeros sequence, e.g., as described below.

In other aspects, the predefined bit sequence may include any other sequence, for example, an all-ones sequence, and/or any other additional or alternative sequence.

In some demonstrative aspects, controller 154 may be configured to control, trigger, cause, and/or instruct the STA implemented by device 140 to process a MAC header of a frame from another STA to identify a PN field having a size of less than 6 bytes, e.g., as described below.

In some demonstrative aspects, controller 154 may be configured to control, trigger, cause, and/or instruct the STA implemented by device 140 to process the MAC header of the frame to identify a MIC in a MIC field, which may have a size of less than 16 bytes, e.g., as described below.

In some demonstrative aspects, controller 154 may be configured to control, trigger, cause, and/or instruct the STA implemented by device 140 to authenticate one or more fields of the MAC header of the frame, for example, according to a MAC header protection mechanism, e.g., as described below.

In some demonstrative aspects, controller 154 may be configured to control, trigger, cause, and/or instruct the STA implemented by device 140 to authenticate the one or more fields of the MAC header of the frame, for example, according to a GMAC-256 protection mechanism, e.g., as described below.

In some demonstrative aspects, controller 154 may be configured to control, trigger, cause, and/or instruct the STA implemented by device 140 to authenticate the one or more fields of the MAC header of the frame, for example, based on the MIC in the MIC field and/or the PN field, e.g., as described below.

In some demonstrative aspects, controller 154 may be configured to control, trigger, cause, and/or instruct the STA implemented by device 140 to authenticate the one or more fields of the MAC header of the frame, for example, based on the MIC in the MIC field and/or the PN field, for example, according to the GMAC-256 protection mechanism, e.g., as described below.

In some demonstrative aspects, the frame received by the STA implemented by device 140 may include the frame transmitted by the STA implemented by device 102, e.g., as described above.

In some demonstrative aspects, controller 154 may be configured to control, trigger, cause, and/or instruct the STA implemented by device 140 to identify a first PN value having a size of less than 6 bytes in the PN field, e.g., as described below.

In some demonstrative aspects, controller 154 may be configured to control, trigger, cause, and/or instruct the STA implemented by device 140 to determine a calculated MIC, for example, according to a second PN value having a size of 6 bytes, e.g., as described below.

In some demonstrative aspects, the second PN value may be based on the first PN value, e.g., as described below.

In some demonstrative aspects, the second PN value may include the first PN value appended with a predefined bit sequence, e.g., as described below.

In some demonstrative aspects, the predefined bit sequence may be configured to have a length equal to a difference between 6 bytes and the size of the first PN value, e.g., as described below.

In some demonstrative aspects, the predefined bit sequence may include an all-zeros sequence.

In other aspects, the predefined bit sequence may include any other sequence, for example, an all-ones sequence, and/or any other additional or alternative sequence.

In some demonstrative aspects, controller 154 may be configured to control, trigger, cause, and/or instruct the STA implemented by device 140 to authenticate the one or more fields of the MAC header of the frame, for example, based on a comparison between the calculated MIC and the MIC in the MIC field, e.g., as described below.

In some demonstrative aspects, device 102, device 140, and/or device 160 may be configured to implement one or more operations and/or functionalities of a frame protection mechanism, e.g., as described below.

In some demonstrative aspects, device 102, device 140, and/or device 160 may be configured to implement one or more operations and/or functionalities of a control frame protection mechanism, which may be configured to support protection of control frames, e.g., as described below.

In some demonstrative aspects, device 102, device 140, and/or device 160 may be configured to implement one or more operations and/or functionalities of a MAC header protection mechanism, which may be configured to support protection of one or more fields of a MAC header, e.g., as described below.

In some demonstrative aspects, the control frame protection mechanism and/or the MAC header protection mechanism may be configured to utilize a protection mechanism, e.g., a GMAC-256/GCMP-256 mechanism, for example, to support a relatively high security level and/or relatively easy implementation.

In some demonstrative aspects, the control frame protection mechanism and/or the MAC header protection mechanism may be configured to utilize truncation of a MIC, for example, according to a truncation level, which may be configured, for example, based on a size of a message, to be protected by the MIC, e.g., as described below.

In some demonstrative aspects, the control frame protection mechanism and/or the MAC header protection mechanism may be configured to utilize truncation of the MIC, for example, according to a truncation level, which may be configured, for example, based on a risk analysis with respect to a security level supported by the truncated MIC, e.g., as described below.

In some demonstrative aspects, the control frame protection mechanism and/or the MAC header protection mechanism may be configured to utilize truncation of the MIC, for example, according to a truncation level, which may be configured, for example, based on a trade-off between overhead and security level.

For example, using a relatively large MIC, e.g., without truncation, may result in increased overhead.

For example, an impact of the additional overhead of the MIC on performance may increase, for example, with a frequency of transmissions utilizing the MIC. For example, the additional overhead of the MIC may have a relatively high impact on performance, for example, in case the MIC is implemented for types of frames, e.g., control frames, which may be transmitted frequently.

For example, truncating the MIC to an arbitrary small size, e.g., in order to save on overhead, may result in a security risk.

In some demonstrative aspects, the control frame protection mechanism may be configured to utilize truncation of the MIC field and/or the PN field, for example, according to a truncation level, which may be configured, for example, based on one or more characteristics of the control frame, for example, while maintaining an adequate security level, for example, in compliance with NIST guidelines, e.g., as described below.

In some demonstrative aspects, the MAC header protection mechanism may be configured to utilize truncation of the MIC field and/or the PN field, for example, according to a truncation level, which may be configured, for example, based on one or more characteristics of the MAC header, for example, while maintaining an adequate security level, for example, in compliance with NIST guidelines, e.g., as described below.

In some demonstrative aspects, the control frame protection mechanism may be configured to implement a MIC size and/or a PN size, which may be determined, for example, based on a size of the message to be protected, e.g., a size of the control frame, and/or a frequency of use of the message to be protected, e.g., a frequency of use of the control frame, e.g., as described below.

In some demonstrative aspects, the MAC header protection mechanism may be configured to implement a MIC size and/or a PN size, which may be determined, for example, based on a size of the message to be protected, e.g., a size of the MAC header, and/or a frequency of use of the message to be protected, e.g., a frequency of use of frames including the MAC header, e.g., as described below.

For example, a size of a MIC implemented for protection of a message may have an impact on a maximal supported length of the message, to ensure an adequate security level, for example, in compliance with NIST guidelines, e.g., as described below.

For example, a size of a MIC implemented for protection of a message may have an impact on a maximal number of times that a same authentication function may be used before being required to set up a new authentication function, for example, to ensure an adequate security level, for example, in compliance with NIST guidelines, e.g., as described below.

For example, a size of a PN implemented for protection of a message may impose a limit on the number of times that the same authentication function may be used before being required to set up a new authentication function.

For example, a MIC having a size of 32 bits (4 bytes) may be configured to support the following combinations of maximal message length (Maximum Combined Length of the Ciphertext and AAD In a Single Packet) and the number of times that the same authentication function may be used (Maximum Invocations of the Authenticated Decryption Function), e.g., in accordance with NIST guidelines:

TABLE 1

| Maximum Combined | Maximum |
|---|---|
| Length of the | Invocations of the |
| Ciphertext and | Authenticated |
| AAD In a Single | Decryption |
| Packet (bytes) | Function |
| 2⁵ | 2²² |
| 2⁶ | 2²⁰ |
| 2⁷ | 2¹⁸ |
| 2⁸ | 2¹⁵ |
| 2⁹ | 2¹³ |
| 2¹⁰ | 2¹¹ |

For example, according to the first line of Table 1, in case a MIC size of 32 bits (4 bytes) is implemented, and the maximal length of the single packet is limited to 2⁵ bytes, then the authentication function (decryption function) may be used for up to 2²² times, for example, without invoking security risks.

For example, it may be noted from Table 1 that a 4-byte MIC (tag) may be suitable for protection of relatively short messages.

For example, according to the last line of Table 1, in case a MIC size of 32 bits (4 bytes) is implemented, the maximal length of the single packet may be limited to 2¹⁰=1024 bytes. However, it is noted that in such case only up to 2¹¹=2048 re-usages of the decryption function may be allowed, which may result in frequent rekeying.

For example, a MIC having a size of 64 bits (8 bytes) may be configured to support the following combinations of maximal message length (Maximum Combined Length of the Ciphertext and AAD In a Single Packet) and the number of times that the same authentication function may be used (Maximum Invocations of the Authenticated Decryption Function), e.g., in accordance with NIST guidelines:

TABLE 2

| Maximum Combined | Maximum |
|---|---|
| Length of the | Invocations of the |
| Ciphertext and | Authenticated |
| AAD In a Single | Decryption |
| Packet (bytes) | Function |
| 2¹⁵ | 2³² |
| 2¹⁷ | 2²⁹ |
| 2¹⁹ | 2²⁶ |
| 2²¹ | 2²³ |
| 2²³ | 2²⁰ |
| 2²⁵ | 2¹⁷ |

For example, according to the first line of Table 2, in case a MIC size of 64 bits (8 bytes) is implemented, and the maximal length of the single packet is limited to 2¹⁵ bytes, then the decryption function may be used for up to 2³² times, for example, without invoking security risks.

In some demonstrative aspects, the control frame protection mechanism may be configured to utilize an 8-byte MIC (tag), which may be sufficient, for example, to support a secure control frame with a size of up to 2¹⁵ (32768) bytes, e.g., in compliance with the first line of Table 2.

In some demonstrative aspects, the control frame protection mechanism may be configured to utilize a PN with a size of 4 bytes (32 bits), which may be sufficient for complying with the constraint, per the first line of Table 2, that the decryption function may be used up to 2³² (˜4*10⁹=4 billion) times.

In some demonstrative aspects, the MAC header protection mechanism may be configured, for example, based on an assumption that a size of the MAC header may be relatively small. For example, for MAC header protection, a size of the MAC header may most likely not be more than 36 bytes, e.g., based on a longest MAC header among the different data and management frame formats.

In some demonstrative aspects, the MAC header protection mechanism may be configured to utilize an 8-byte MIC (tag), which may be sufficient, for example, to support the size of the MAC header.

In some demonstrative aspects, the MAC header protection mechanism may be configured to utilize a PN with a size of 4 bytes (32 bits), which may be sufficient for complying with the constraint, per the first line of Table 2, that the decryption function may be used up to 2³² (˜4*10⁹=4 billion) times.

In some demonstrative aspects, the MAC header protection mechanism may be configured to utilize a 4-byte MIC (tag), which may also be sufficient, for example, to support the size of the MAC header.

In some demonstrative aspects, the MAC header protection mechanism may be configured to utilize a PN with a size of 3 bytes (24 bits), which may be sufficient for complying with the constraint, per the third line of Table 1, that the decryption function may be used up to 2¹⁸ times.

In some demonstrative aspects, device 102, device 140, and/or device 160 may be configured to implement one or more operations of a control frame protection mechanism, which may be configured to support protection of contents of a control frame, e.g., as described below.

In some demonstrative aspects, the frame control protection mechanism may mandate a GMAC-256 code as a cipher to be used with Broadcast/multicast integrity protocol (BIP) for group addressed control frame protection, for example, if a MIC only mechanism is used.

In some demonstrative aspects, the frame control protection mechanism may mandate the authentication code GCMP-256 as a cipher to encrypt group addressed control frames, for example, if an encryption mechanism is used.

In some demonstrative aspects, the frame control protection mechanism may be configured to support using a BIP as a protection protocol for individually addressed control frame protection.

In some demonstrative aspects, the frame control protection mechanism may be configured to support using the BIP for individually addressed control frame protection, for example, by using a same key for an individually addressed control frame and a group addressed control frame.

In some demonstrative aspects, the frame control protection mechanism may be configured to support using the BIP for individually addressed control frame protection, for example, by using a different key for each individually addressed control frame, and using one key for group addressed control frames.

In some demonstrative aspects, the frame control protection mechanism may be configured to use a MIC size of 8 bytes, and/or a PN field size (also referred to as “over the air PN size”) of 4 bytes, for example, when a GMAC-256 code or a GCMP-256 code is used for control frame protection.

For example, an actual PN, which is fed into an authentication algorithm, may be, e.g., may still be, 6 bytes long, for example, by appending 2 additional bytes with a predefined sequence, for example, an all-zeros sequence, after receiving the control frame.

For example, using a 6-byte PN may, e.g., will, allow to use an authentication algorithm, e.g., in accordance with an IEEE 802.11 Specification.

In some demonstrative aspects, the frame control protection mechanism may be configured to support using any other additional or alternative MIC and/or PN truncated combination.

For example, the frame control protection mechanism may be configured to use a MIC size of 8 bytes and/or an over the air PN size of 6 bytes, e.g., without truncation of the PN, for example, in compliance with NIST security requirements.

For example, the frame control protection mechanism may be configured to follow the guidelines of NIST analysis to balance the maximum size of a control frame and/or the maximum number of decryption/MIC verification, e.g., as described above.

In some demonstrative aspects, device 102, device 140, and/or device 160 may be configured to implement one or more operations of a MAC header protection mechanism, which may be configured to support protection of contents of one or more subfields of a MAC header of a frame, e.g., as described below.

In some demonstrative aspects, the frame may include a management frame.

In some demonstrative aspects, the frame may include a data frame.

In some demonstrative aspects, the frame may include a group addressed data frame, and/or a group addressed management frame.

In some demonstrative aspects, the MAC header protection mechanism may mandate a GMAC-256 code as a cipher to be used with BIP for MAC header protection, for example, of a data frame and/or a management frame, for example, if a MIC only mechanism is used.

In some demonstrative aspects, the frame may include an individually addressed data frame, and/or an individually addressed management frame.

In some demonstrative aspects, the MAC header protection mechanism may be configured to support using a BIP for MAC header protection of an individually addressed data frame and/or an individually addressed management frame.

In some demonstrative aspects, the MAC header protection mechanism may be configured to support using the BIP for individually addressed frames, for example, by using a same key for MAC header protection for the individually addressed data frame and/or individually addressed management frame, and for MAC header protection for a group addressed data frame and/or a group addressed management frame.

In some demonstrative aspects, the MAC header protection mechanism may be configured to support using the BIP for individually addressed frames, for example, by using a different key for MAC header protection for each individually addressed data frame and/or each individually addressed management frame, and using one key for MAC header protection for a group addressed data frame and/or a group addressed management frame.

In some demonstrative aspects, the MAC header protection mechanism may mandate a GCMP-256 code as a cipher to encrypt one or more parts, e.g., certain parts, of a MAC header of a data frame and/or a management frame, for example, if an encryption mechanism is used.

In some demonstrative aspects, the MAC header protection mechanism may be configured to use a MIC size of 8 bytes, and/or an over the air PN size of 4 bytes, for example, when a GMAC-256 code or a GCMP-256 code is used for MAC header protection.

For example, an actual PN, which is fed into an authentication algorithm, may be, e.g., may still be, 6 bytes long, for example, by appending 2 additional bytes with a predefined sequence, for example, an all-zeros sequence, after receiving the frame including the MAC header.

For example, using a 6-byte PN may, e.g., will, allow to use an authentication algorithm, e.g., in accordance with an IEEE 802.11 Specification.

In some demonstrative aspects, the MAC header protection mechanism may be configured to use a MIC size of 4 bytes, and/or an over the air PN size of 3 bytes, for example, when a GMAC-256 code or a GCMP-256 code is used for MAC header protection.

For example, an actual PN, which is fed into an authentication algorithm, may be, e.g., may still be, 6 bytes long, for example, by appending 3 additional bytes with a predefined sequence, for example, an all-zeros sequence, after receiving the frame including the MAC header.

For example, using a 6-byte PN may, e.g., will, allow to use an authentication algorithm, e.g., in accordance with an IEEE 802.11 Specification.

In some demonstrative aspects, the MAC header protection mechanism may be configured to support using any other additional or alternative MIC and/or PN truncated combination.

For example, the frame MAC header mechanism may be configured to use a MIC size of 8 bytes and/or an over the air PN size of 6 bytes, e.g., without truncation of the PN, for example, in compliance with NIST security requirements.

For example, the MAC header protection mechanism may be configured to follow the guidelines of NIST analysis to balance the maximum size of a MAC header and/or the maximum number of decryption/MIC verification, e.g., as described above.

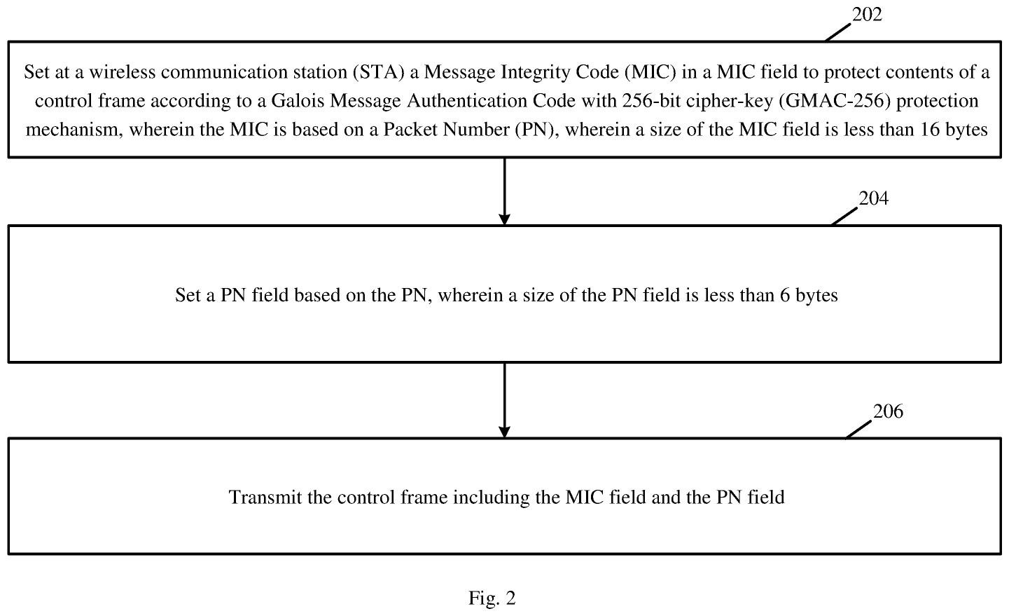

Reference is made to FIG. 2, which schematically illustrates a method of control frame protection, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 202, the method may include setting, at a STA, a MIC in a MIC field to protect contents of a control frame, for example, according to a GMAC-256 protection mechanism. For example, the MIC may be based on a PN. For example, a size of the MIC field may be less than 16 bytes. For example, controller 124 (FIG. 1) may be configured to cause, trigger, and/or control device 102 (FIG. 1) to set a MIC in a MIC field to protect contents of a control frame, for example, according to a GMAC-256 protection mechanism, e.g., as described above.

As indicated at block 204, the method may include setting a PN field, for example, based on the PN. For example, the PN field may have a size of less than 6 bytes. For example, controller 124 (FIG. 1) may be configured to cause, trigger, and/or control device 102 (FIG. 1) to set a PN field based on the PN, wherein a size of the PN field may include a size of less than 6 bytes, e.g., as described above.

As indicated at block 206, the method may include transmitting the control frame including the MIC field and the PN field. For example, controller 124 (FIG. 1) may be configured to cause, trigger, and/or control device 102 (FIG. 1) to transmit the control frame, which includes the MIC field and the PN field, e.g., as described above.

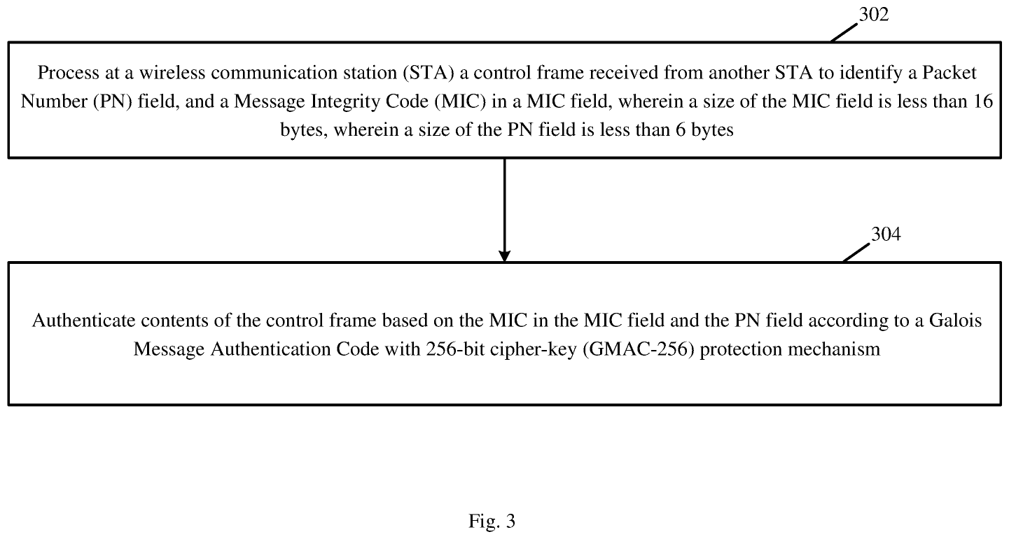

Reference is made to FIG. 3, which schematically illustrates a method of control frame protection, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include processing, at a STA, a control frame received from another STA to identify a PN field, and a MIC in a MIC field. For example, a size of the MIC field may be less than 16 bytes. For example, a size of the PN field may be less than 6 bytes. For example, controller 154 (FIG. 1) may be configured to cause, trigger, and/or control device 140 (FIG. 1) to process a control frame received from device 102 (FIG. 1) to identify a PN field, and a MIC in a MIC field, e.g., as described above.

As indicated at block 304, the method may include authenticating contents of the control frame, for example, based on the MIC in the MIC field and the PN field, for example, according to a GMAC-256 protection mechanism. For example, controller 154 (FIG. 1) may be configured to cause, trigger, and/or control device 140 (FIG. 1) to authenticate contents of the control frame based on the MIC in the MIC field and the PN field according to a GMAC-256 protection mechanism, e.g., as described above.

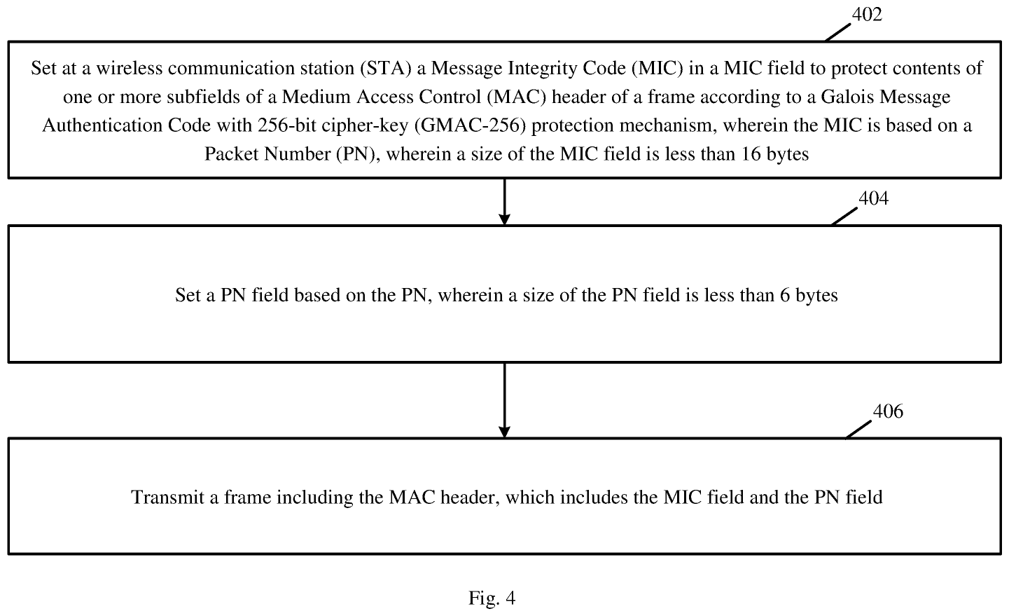

Reference is made to FIG. 4, which schematically illustrates a method of MAC header protection, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include setting, at a STA, a MIC in a MIC field to protect contents of one or more subfields of a MAC header of a frame, for example, according to a GMAC-256 protection mechanism. For example, the MIC may be based on a PN. For example, a size of the MIC field may be less than 16 bytes. For example, controller 124 (FIG. 1) may be configured to cause, trigger, and/or control device 102 (FIG. 1) to set a MIC in a MIC field to protect contents of one or more subfields of a MAC header of a frame, for example, according to a GMAC-256 protection mechanism, e.g., as described above.

As indicated at block 404, the method may include setting a PN field, for example, based on the PN. For example, a size of the PN field may be less than 6 bytes. For example, controller 124 (FIG. 1) may be configured to cause, trigger, and/or control device 102 (FIG. 1) to set a PN field based on the PN, wherein a size of the PN field may be less than 6 bytes, e.g., as described above.

As indicated at block 406, the method may include transmitting a frame including the MAC header, which includes the MIC field and the PN field. For example, controller 124 (FIG. 1) may be configured to cause, trigger, and/or control device 102 (FIG. 1) to transmit a frame including the MAC header, which includes the MIC field and the PN field, e.g., as described above.

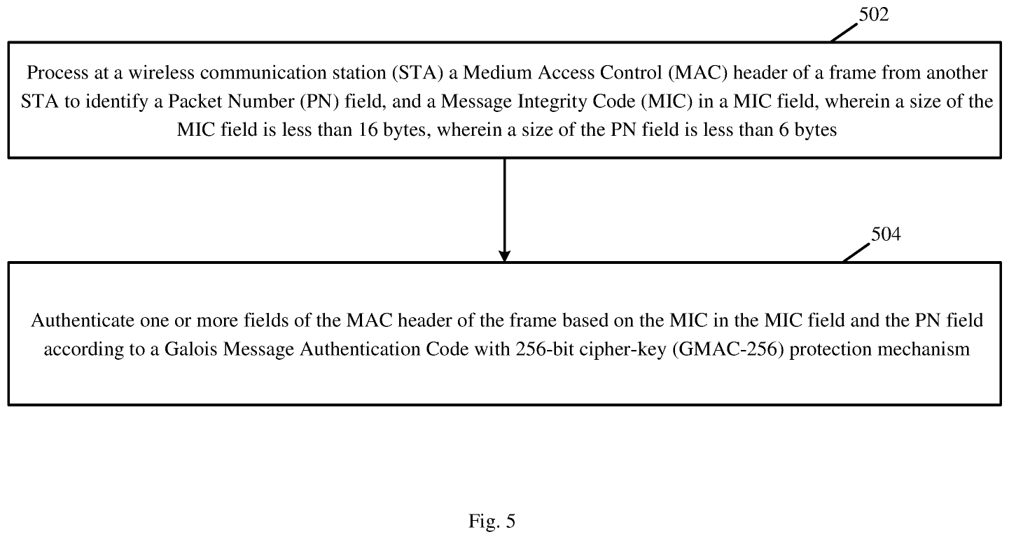

Reference is made to FIG. 5, which schematically illustrates a method of MAC header protection, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include processing, at a STA, a MAC header of a frame from another STA to identify a PN field, and a MIC in a MIC field. For example, a size of the MIC field may be less than 16 bytes. For example, a size of the PN field may be less than 6 bytes. For example, controller 154 (FIG. 1) may be configured to cause, trigger, and/or control device 140 (FIG. 1) to process a MAC header of a frame from device 102 (FIG. 1) to identify a PN field, and a MIC in a MIC field, e.g., as described above.

As indicated at block 504, the method may include authenticating one or more fields of the MAC header of the frame, for example, based on the MIC in the MIC field and the PN field, for example, according to a GMAC-256 protection mechanism. For example, controller 154 (FIG. 1) may be configured to cause, trigger, and/or control device 140 (FIG. 1) to authenticate one or more fields of the MAC header of the frame, for example, based on the MIC in the MIC field and the PN field, for example, according to a GMAC-256 protection mechanism, e.g., as described above.

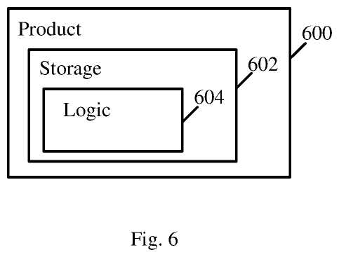

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1, 2, 3, 4, and/or 5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a wireless communication station (STA) to set a Message Integrity Code (MIC) in a MIC field to protect contents of a control frame according to a Galois Message Authentication Code with 256-bit cipher-key (GMAC-256) protection mechanism, wherein the MIC is based on a Packet Number (PN), wherein a size of the MIC field is less than 16 bytes; set a PN field based on the PN, wherein a size of the PN field is less than 6 bytes; and transmit the control frame comprising the MIC field and the PN field.

Example 2 includes the subject matter of Example 1, and optionally, wherein the apparatus is configured to cause the STA to set the PN field to a first PN value having a size of less than 6 bytes, and to determine the MIC according to a second PN value having a size of 6 bytes, wherein the second PN value is based on the first PN value.

Example 3 includes the subject matter of Example 2, and optionally, wherein the second PN value comprises the first PN value appended with a predefined bit sequence having a length equal to a difference between 6 bytes and the size of the first PN value.

Example 4 includes the subject matter of Example 3, and optionally, wherein the predefined bit sequence comprises an all-zeros sequence.

Example 5 includes the subject matter of any one of Examples 1-4, and optionally, wherein the size of the MIC field is 8 bytes.

Example 6 includes the subject matter of any one of Examples 1-4, and optionally, wherein the size of the MIC field is 4 bytes.

Example 7 includes the subject matter of any one of Examples 1-6, and optionally, wherein the size of the PN field is 4 bytes.

Example 8 includes the subject matter of any one of Examples 1-6, and optionally, wherein the size of the PN field is 3 bytes.

Example 9 includes the subject matter of any one of Examples 1-8, and optionally, wherein the control frame comprises a trigger frame, a Block Acknowledgement (BA) frame, or a BA Request (BAR) frame.

Example 10 includes the subject matter of any one of Examples 1-9, and optionally, wherein the control frame comprises a group addressed control frame.

Example 11 includes the subject matter of any one of Examples 1-9, and optionally, wherein the control frame comprises an individually addressed control frame.

Example 12 includes the subject matter of any one of Examples 1-11, and optionally, wherein the control frame comprises a frame control field comprising a type subfield set to “01”.

Example 13 includes the subject matter of any one of Examples 1-12, and optionally, comprising a radio to transmit the control frame from the STA.

Example 14 includes the subject matter of Example 13, and optionally, comprising one or more antennas connected to the radio, and a processor to execute instructions of an operating system of the STA.

Example 15 includes an apparatus comprising logic and circuitry configured to cause a wireless communication station (STA) to process a control frame received from another STA to identify a Packet Number (PN) field, and a Message Integrity Code (MIC) in a MIC field, wherein a size of the MIC field is less than 16 bytes, wherein a size of the PN field is less than 6 bytes; and authenticate contents of the control frame based on the MIC in the MIC field and the PN field according to a Galois Message Authentication Code with 256-bit cipher-key (GMAC-256) protection mechanism.

Example 16 includes the subject matter of Example 15, and optionally, wherein the apparatus is configured to cause the STA to identify a first PN value having a size of less than 6 bytes in the PN field; determine a calculated MIC according to a second PN value having a size of 6 bytes, wherein the second PN value is based on the first PN value; and authenticate the contents of the control frame based on a comparison between the calculated MIC and the MIC in the MIC field.

Example 17 includes the subject matter of Example 16, and optionally, wherein the second PN value comprises the first PN value appended with a predefined bit sequence having a length equal to a difference between 6 bytes and the size of the first PN value.

Example 18 includes the subject matter of Example 17, and optionally, wherein the predefined bit sequence comprises an all-zeros sequence.

Example 19 includes the subject matter of any one of Examples 15-18, and optionally, wherein the size of the MIC field is 8 bytes.

Example 20 includes the subject matter of any one of Examples 15-18, and optionally, wherein the size of the MIC field is 4 bytes.

Example 21 includes the subject matter of any one of Examples 15-20, and optionally, wherein the size of the PN field is 4 bytes.

Example 22 includes the subject matter of any one of Examples 15-20, and optionally, wherein the size of the PN field is 3 bytes.

Example 23 includes the subject matter of any one of Examples 15-22, and optionally, wherein the control frame comprises a trigger frame, a Block Acknowledgement (BA) frame, or a BA Request (BAR) frame.

Example 24 includes the subject matter of any one of Examples 15-23, and optionally, wherein the control frame comprises a group addressed control frame.

Example 25 includes the subject matter of any one of Examples 15-23, and optionally, wherein the control frame comprises an individually addressed control frame.

Example 26 includes the subject matter of any one of Examples 15-25, and optionally, wherein the control frame comprises a frame control field comprising a type subfield set to “01”.

Example 27 includes the subject matter of any one of Examples 15-26, and optionally, comprising a radio to receive the control frame from the other STA.

Example 28 includes the subject matter of Example 27, and optionally, comprising one or more antennas connected to the radio, and a processor to execute instructions of an operating system of the STA.

Example 29 includes an apparatus comprising logic and circuitry configured to cause a wireless communication station (STA) to set a Message Integrity Code (MIC) in a MIC field to protect contents of one or more subfields of a Medium Access Control (MAC) header of a frame according to a Galois Message Authentication Code with 256-bit cipher-key (GMAC-256) protection mechanism, wherein the MIC is based on a Packet Number (PN), wherein a size of the MIC field is less than 16 bytes; set a PN field based on the PN, wherein a size of the PN field is less than 6 bytes; and transmit a frame comprising the MAC header, wherein the MAC header comprises the MIC field and the PN field.

Example 30 includes the subject matter of Example 29, and optionally, wherein the apparatus is configured to cause the STA to set the PN field to a first PN value having a size of less than 6 bytes, and to determine the MIC according to a second PN value having a size of 6 bytes, wherein the second PN value is based on the first PN value.

Example 31 includes the subject matter of Example 30, and optionally, wherein the second PN value comprises the first PN value appended with a predefined bit sequence having a length equal to a difference between 6 bytes and the size of the first PN value.

Example 32 includes the subject matter of Example 31, and optionally, wherein the predefined bit sequence comprises an all-zeros sequence.

Example 33 includes the subject matter of any one of Examples 29-32, and optionally, wherein the size of the MIC field is 8 bytes.

Example 34 includes the subject matter of any one of Examples 29-32, and optionally, wherein the size of the MIC field is 4 bytes.

Example 35 includes the subject matter of any one of Examples 29-34, and optionally, wherein the size of the PN field is 4 bytes.

Example 36 includes the subject matter of any one of Examples 29-34, and optionally, wherein the size of the PN field is 3 bytes.

Example 37 includes the subject matter of any one of Examples 29-36, and optionally, wherein the one or more subfields of the MAC header comprises at least one of a sequence control subfield, a Quality of Service (QOS) control subfield, a High-Throughput (HT) control subfield, or a Power Management (PM) subfield.

Example 38 includes the subject matter of any one of Examples 29-37, and optionally, wherein the frame comprises a management frame.

Example 39 includes the subject matter of Example 38, and optionally, wherein the management frame comprises a frame control field comprising a type subfield set to “00”.

Example 40 includes the subject matter of any one of Examples 29-37, and optionally, wherein the frame comprises a data frame.

Example 41 includes the subject matter of Example 40, and optionally, wherein the data frame comprises a frame control field comprising a type subfield set to “10”.

Example 42 includes the subject matter of any one of Examples 29-41, and optionally, wherein the frame comprises a group addressed frame.

Example 43 includes the subject matter of any one of Examples 29-42, and optionally, wherein the control frame comprises an individually addressed frame.

Example 44 includes the subject matter of any one of Examples 29-42, and optionally, comprising a radio to transmit the frame from the STA.

Example 45 includes the subject matter of Example 44, and optionally, comprising one or more antennas connected to the radio, and a processor to execute instructions of an operating system of the STA.

Example 46 includes an apparatus comprising logic and circuitry configured to cause a wireless communication station (STA) to process a Medium Access Control (MAC) header of a frame from another STA to identify a Packet Number (PN) field, and a Message Integrity Code (MIC) in a MIC field, wherein a size of the MIC field is less than 16 bytes, wherein a size of the PN field is less than 6 bytes; and authenticate one or more fields of the MAC header of the frame based on the MIC in the MIC field and the PN field according to a Galois Message Authentication Code with 256-bit cipher-key (GMAC-256) protection mechanism.

Example 47 includes the subject matter of Example 46, and optionally, wherein the apparatus is configured to cause the STA to identify a first PN value having a size of less than 6 bytes in the PN field; determine a calculated MIC according to a second PN value having a size of 6 bytes, wherein the second PN value is based on the first PN value; and authenticate the one or more fields of the MAC header of the frame based on a comparison between the calculated MIC and the MIC in the MIC field.

Example 48 includes the subject matter of Example 47, and optionally, wherein the second PN value comprises the first PN value appended with a predefined bit sequence having a length equal to a difference between 6 bytes and the size of the first PN value.

Example 49 includes the subject matter of Example 48, and optionally, wherein the predefined bit sequence comprises an all-zeros sequence.

Example 50 includes the subject matter of any one of Examples 46-49, and optionally, wherein the size of the MIC field is 8 bytes.

Example 51 includes the subject matter of any one of Examples 46-49, and optionally, wherein the size of the MIC field is 4 bytes.

Example 52 includes the subject matter of any one of Examples 46-51, and optionally, wherein the size of the PN field is 4 bytes.

Example 53 includes the subject matter of any one of Examples 46-51, and optionally, wherein the size of the PN field is 3 bytes.

Example 54 includes the subject matter of any one of Examples 46-53, and optionally, wherein the control frame comprises a trigger frame, a Block Acknowledgement (BA) frame, or a BA Request (BAR) frame.

Example 55 includes the subject matter of any one of Examples 46-54, and optionally, wherein the one or more subfields of the MAC header comprises at least one of a sequence control subfield, a Quality of Service (QOS) control subfield, a High-Throughput (HT) control subfield, or a Power Management (PM) subfield.

Example 56 includes the subject matter of any one of Examples 46-55, and optionally, wherein the frame comprises a management frame.

Example 57 includes the subject matter of Example 56, and optionally, wherein the management frame comprises a frame control field comprising a type subfield set to “00”.

Example 58 includes the subject matter of any one of Examples 46-55, and optionally, wherein the frame comprises a data frame.

Example 59 includes the subject matter of Example 58, and optionally, wherein the data frame comprises a frame control field comprising a type subfield set to “10”.

Example 60 includes the subject matter of any one of Examples 46-59, and optionally, wherein the frame comprises a group addressed frame.

Example 61 includes the subject matter of any one of Examples 46-59, and optionally, wherein the control frame comprises an individually addressed frame.

Example 62 includes the subject matter of any one of Examples 46-61, and optionally, comprising a radio to receive the frame from the other STA.

Example 63 includes the subject matter of Example 62, and optionally, comprising one or more antennas connected to the radio, and a processor to execute instructions of an operating system of the STA.

Example 64 includes a wireless communication device comprising the apparatus of any of Examples 1-63.

Example 65 includes a mobile device comprising the apparatus of any of Examples 1-63.

Example 66 includes an apparatus comprising means for executing any of the described operations of any of Examples 1-63.

Example 67 includes a product comprising one or more tangible computer-readable non-transitory storage media comprising instructions operable to, when executed by at least one processor, enable the at least one processor to cause a wireless communication device to perform any of the described operations of any of Examples 1-63.

Example 68 includes an apparatus comprising: a memory interface; and processing circuitry configured to: perform any of the described operations of any of Examples 1-63.

Example 69 includes a method comprising any of the described operations of any of Examples 1-63.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication station (STA) to:
set a Message Integrity Code (MIC) in a MIC field to protect contents of a control frame according to a Galois Message Authentication Code with 256-bit cipher-key (GMAC-256) protection mechanism, wherein the MIC is based on a Packet Number (PN), wherein a size of the MIC field is less than 16 bytes;
set a PN field based on the PN, wherein a size of the PN field is less than 6 bytes; and
transmit the control frame comprising the MIC field and the PN field.

2. The apparatus of claim 1 configured to cause the STA to set the PN field to a first PN value having a size of less than 6 bytes, and to determine the MIC according to a second PN value having a size of 6 bytes, wherein the second PN value is based on the first PN value.

3. The apparatus of claim 2, wherein the second PN value comprises the first PN value appended with a predefined bit sequence having a length equal to a difference between 6 bytes and the size of the first PN value.

4. The apparatus of claim 3, wherein the predefined bit sequence comprises an all-zeros sequence.

5. The apparatus of claim 1, wherein the size of the MIC field is 8 bytes.

6. The apparatus of claim 1, wherein the size of the MIC field is 4 bytes.

7. The apparatus of claim 1, wherein the size of the PN field is 4 bytes.

8. The apparatus of claim 1, wherein the size of the PN field is 3 bytes.

9. The apparatus of claim 1, wherein the control frame comprises a trigger frame, a Block Acknowledgement (BA) frame, or a BA Request (BAR) frame.

10. The apparatus of claim 1, wherein the control frame comprises a group addressed control frame.

11. The apparatus of claim 1, wherein the control frame comprises an individually addressed control frame.

12. The apparatus of claim 1, wherein the control frame comprises a frame control field comprising a type subfield set to “01”.

13. The apparatus of claim 1 comprising a radio to transmit the control frame from the STA.

14. The apparatus of claim 13 comprising one or more antennas connected to the radio, and a processor to execute instructions of an operating system of the STA.

15. A product comprising one or more tangible computer-readable non-transitory storage media comprising instructions operable to, when executed by at least one processor, enable the at least one processor to cause a wireless communication station (STA) to:
set a Message Integrity Code (MIC) in a MIC field to protect contents of a control frame according to a Galois Message Authentication Code with 256-bit cipher-key (GMAC-256) protection mechanism, wherein the MIC is based on a Packet Number (PN), wherein a size of the MIC field is less than 16 bytes;
set a PN field based on the PN, wherein a size of the PN field is less than 6 bytes; and
transmit the control frame comprising the MIC field and the PN field.

16. The product of claim 15, wherein the instructions, when executed, cause the STA to set the PN field to a first PN value having a size of less than 6 bytes, and to determine the MIC according to a second PN value having a size of 6 bytes, wherein the second PN value is based on the first PN value.

17. The product of claim 16, wherein the second PN value comprises the first PN value appended with a predefined bit sequence having a length equal to a difference between 6 bytes and the size of the first PN value.

18. The product of claim 15, wherein the size of the PN field is 3 bytes.

19. An apparatus for a wireless communication station (STA), the apparatus comprising:
means for setting a Message Integrity Code (MIC) in a MIC field to protect contents of a control frame according to a Galois Message Authentication Code with 256-bit cipher-key (GMAC-256) protection mechanism, wherein the MIC is based on a Packet Number (PN), wherein a size of the MIC field is less than 16 bytes;
means for setting a PN field based on the PN, wherein a size of the PN field is less than 6 bytes; and
means for causing the STA to transmit the control frame comprising the MIC field and the PN field.

20. The apparatus of claim 19 comprising means for setting the PN field to a first PN value having a size of less than 6 bytes, and to determine the MIC according to a second PN value having a size of 6 bytes, wherein the second PN value is based on the first PN value.
